(19) United States
(12) Patent Application Publication
(10) Pub. No.: US 2024/0032086 A1
(43) Pub. Date: Jan. 25, 2024

(54) RELAY METHOD AND RELAY APPARATUS

(71) Applicant: NIPPON TELEGRAPH AND TELEPHONE CORPORATION, Tokyo (JP)

(72) Inventors: Shota NAKAYAMA, Tokyo (JP); Kenichi KAWAMURA, Tokyo (JP); Daisuke MURAYAMA, Tokyo (JP); Takatsune MORIYAMA, Tokyo (JP)

(21) Appl. No.: 18/041,422

(22) PCT Filed: Aug. 27, 2020
(86) PCT No.: PCT/JP2020/032486

§ 371 Date: Feb. 13, 2023

(51) Int. Cl. H04W 72/56

(52) U.S. Cl. CPC H04W 72/56; H04W 84/12

(57) ABSTRACT

A relay method is executed by a relay device that relays communication between each of terminals accommodated by wireless communication and an external device. The relay method includes setting, for each terminal of the terminals, a time period from storing a packet in a queue until transmitting the packet to the terminal as a first time period; and setting, for each terminal of the terminals, a time interval in which the terminal is allowed to transmit a packet by the wireless communication as a second time period corresponding to the first time period.

### TECHNICAL FIELD

The present disclosure relates to a relay method and a relay device.

### BACKGROUND ART

In the related art, as a priority control method for a wireless LAN, enhanced distributed channel access (EDCA) and hybrid coordination function (HCF) controlled channel access (HCCA) are known.

In EDCA, packets are classified into four access categories (ACs) and stored in each transmission queue, and each packet is transmitted according to its degree of priority. Then, before the data is transmitted, waiting is performed for a period of an arbitration inter frame spacing (AIFS) and a contention window (CW), and the data is transmitted when no radio waves are detected. Priority control is realized by setting parameters related to the AIFS and the contention window in each transmission queue (see, for example, NPL 1).

In addition, HCCA is a technique of a central control type in which a transmission time is allocated from an AP to each terminal. In HCCP, the AP and the terminal exchange transmission conditions and allocate a transmission opportunity to each terminal (see, for example, NPL 2).

### CITATION LIST

### Non Patent Literature

[NPL 1] Kenichi Kawamura, Takefumi Hiraguri, Mamoru Ogasawara. “Technique for dynamically updating EDCA parameter for wireless LAN,” NTT Journal, 2007.8
[NPL 2] Masahiro Otani, Naoki Urano, Toru Ueda. “IEEE 802.11e-QoS Enhanced Wireless LAN Standard,” Journal of the Institute of Image Information and Television Engineers Vol. 57, No. 11 (2003)
[NPL 3] IEEE Std 802.11h-2003, IEEE Standard for Information technology—Telecommunications and information exchange between systems—Local and metropolitan area networks—Specific requirements Part 11: Wireless Medium Access Control (MAC) and Physical Layer (PHY) specifications: Amendment 5: Spectrum and transmit power management extensions in the 5 GHz band in Europe

### SUMMARY OF INVENTION

### Technical Problem

In EDCA, since the transmission right is given on the basis of the random number, there is a problem that a frame with a low degree of priority may be transmitted first. Further, HCCA lacks versatility because both the AP and the terminal need to support HCCA.

An object of the present disclosure is to provide a technique of performing appropriate communication control.

### Solution to Problem

According to the disclosed technique,
there is provided a relay method that is executed by a relay device that relays communication between each of terminals accommodated by wireless communication and an external device, the relay method including:
a first setting process in which each of packets to be transmitted to each terminal is stored in a queue and a time for transmitting each packet to each terminal is set to a first time; and
a second setting process in which a second time corresponding to the first time is set in each terminal as a time when the packets can be transmitted from each terminal by the wireless communication.

### Advantageous Effects of Invention

According to the disclosed technique, appropriate communication control can be performed.

### BRIEF DESCRIPTION OF DRAWINGS

FIG. 1 is a diagram illustrating an example of a configuration of a communication system 1 according to an embodiment.

FIG. 2 is a diagram showing an example of a functional configuration of an AP 10 and a control device 30 according to the embodiment.

FIG. 3 is a flowchart illustrating an example of processing of the AP 10 according to the embodiment.

FIG. 4A is a diagram illustrating an example in which the AP 10 according to the embodiment controls a time for transmitting a packet to each STA 20 using a delay queue.

FIG. 4B is a diagram illustrating an example in which the AP 10 according to the embodiment controls a time for transmitting a packet to each STA 20 using a delay queue.

FIG. 5A is a diagram illustrating an example in which the AP 10 according to the embodiment controls a time for transmitting a packet to each STA 20 by scheduling.

FIG. 5B is a diagram illustrating an example in which the AP 10 according to the embodiment controls a time for transmitting a packet to each STA 20 by scheduling.

FIG. 5C is a diagram illustrating an example in which the AP 10 according to the embodiment controls a time for transmitting a packet to each STA 20 by scheduling.

FIG. 6 is a diagram illustrating an example of a transmittable time of each STA 20 according to the embodiment.

FIG. 7 is a diagram showing a format of a Quiet element defined in IEEE 802.11h.

FIG. 8 is a diagram illustrating an example of setting a transmission time according to a use rate of a queue for a terminal according to the embodiment.

FIG. 9 is a diagram illustrating an example of dynamically changing the transmittable time of each STA 20 in accordance with the use rate of a queue for each terminal according to the embodiment.

FIG. 10 is a diagram illustrating an example of dynamically changing the transmittable time of each STA 20 in accordance with a situation related to communication quality in the STA 20 according to the embodiment.

FIG. 11 is a diagram illustrating an example of a configuration of the AP 10 according to the embodiment.

### DESCRIPTION OF EMBODIMENTS

Embodiments of the present disclosure (the present embodiments) will be described below with reference to the drawings. The embodiments described below are merely examples, and the embodiments to which the present disclosure is applied are not limited to the following embodiments.

### <System Configuration>

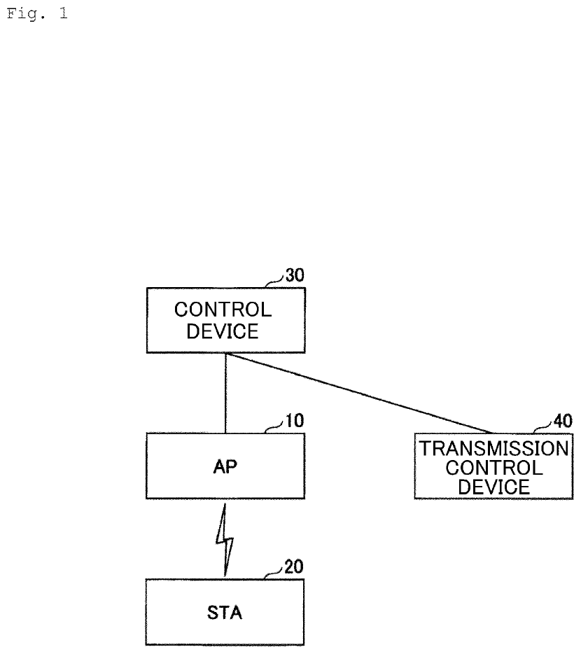

An example of a configuration of a communication system 1 according to an embodiment will be described with reference to FIG. 1. FIG. 1 is a diagram illustrating an example of the configuration of the communication system 1 according to the embodiment. In the example shown in FIG. 1, the communication system 1 includes an access point (AP) 10, one or more stations (STAs, terminals) 20, a control device 30, and a transmission control device 40. The number of devices is not limited to the example shown in FIG. 1.

The AP 10, the control device 30, and the transmission control device 40 are connected by, for example, a local area network (LAN) and a network such as the Internet. The AP 10 and the STA 20 are connected by wireless communication such as a wireless LAN.

The AP 10 is an access point (base station) which accommodates one or more STAs 20. The STA 20 is a terminal that connects wireless communication with the AP 10 and connects to a LAN, the Internet, or the like via the AP 10.

The control device 30 may be a server located on a cloud or a network. The control device 30 is not essential. The transmission control device 40 is, for example, a device that provides a channel quiet function that controls transmission in an uplink direction (communication from the STA 20 to the Internet or the like). The transmission control device 40 is not essential.

### <Functional Configuration>

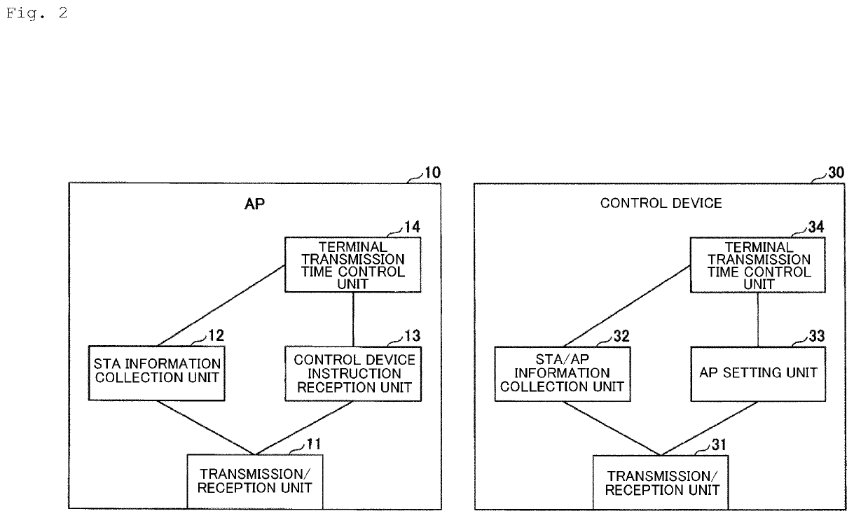

A functional configuration of the AP 10 and the control device 30 according to the embodiment will be described with reference to FIG. 2. FIG. 2 is a diagram showing an example of the functional configuration of the AP 10 and the control device 30 according to the embodiment.

### <<AP 10>>

In the example of FIG. 2, the AP 10 according to an embodiment includes a transmission/reception unit 11, an STA information collection unit 12, a control device instruction reception unit 13, and a terminal transmission time control unit 14. These units may be realized by the cooperation of one or more programs installed in the AP 10 and hardware such as the CPU of the AP 10.

The transmission/reception unit 11 communicates with an external device. The STA information collection unit 12 acquires quality (for example, delay, throughput, etc.) of communication in the STA 20, information of an application in use, and the like. The STA information collection unit 12 may acquire various types of information from the STA 20, for example, by polling or the like. The control device instruction reception unit 13 receives various commands from the control device 30.

The terminal transmission time control unit 14 sets (determines) transmittable time or the rate of time for each terminal. The terminal transmission time control unit 14 changes the transmittable time or the rate of the time for each terminal in accordance with the use rate of the transmission queue of each terminal. The terminal transmission time control unit 14 changes the transmittable time for each terminal on the basis of the information acquired by the STA information collection unit 12.

### <<Control Device 30>>

In the example of FIG. 2, the control device 30 according to an embodiment includes a transmission/reception unit 31, an STA/AP information collection unit 32, an AP setting unit 33, and a terminal transmission time control unit 34. These units may be realized by the cooperation of one or more programs installed in the control device 30 and hardware such as the CPU of the control device 30.

The transmission/reception unit 31 communicates with an external device. The STA/AP information collection unit 32 acquires delay of communication in the STA 20, information of an application in use, and the like. The STA/AP information collection unit 32 may acquire various types of information from the STA 20, for example, by polling or the like. The AP setting unit 33 transmits various commands to the AP 10.

The terminal transmission time control unit 34 sets (determines) transmittable time or the rate of time for each terminal. The terminal transmission time control unit 34 changes the transmittable time or the rate of the time for each terminal in accordance with the use rate of the transmission queue of each terminal. The terminal transmission time control unit 34 changes the transmittable time or the rate of the time for each terminal on the basis of the information acquired by the STA/AP information collection unit 32.

### <Processing>

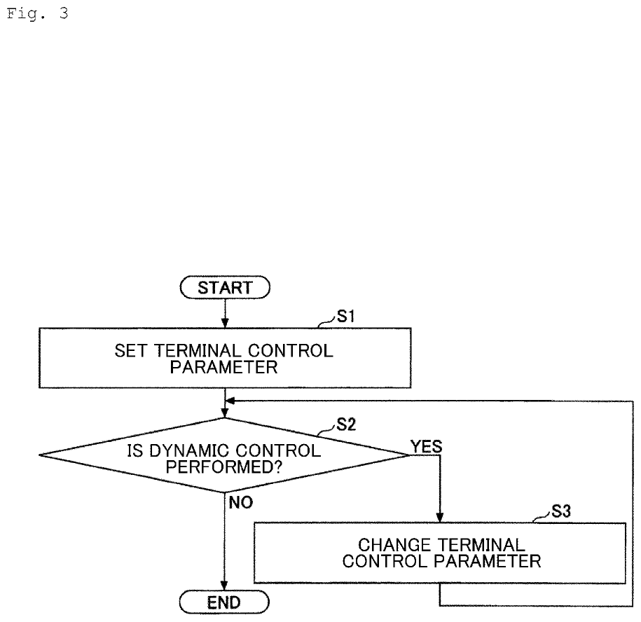

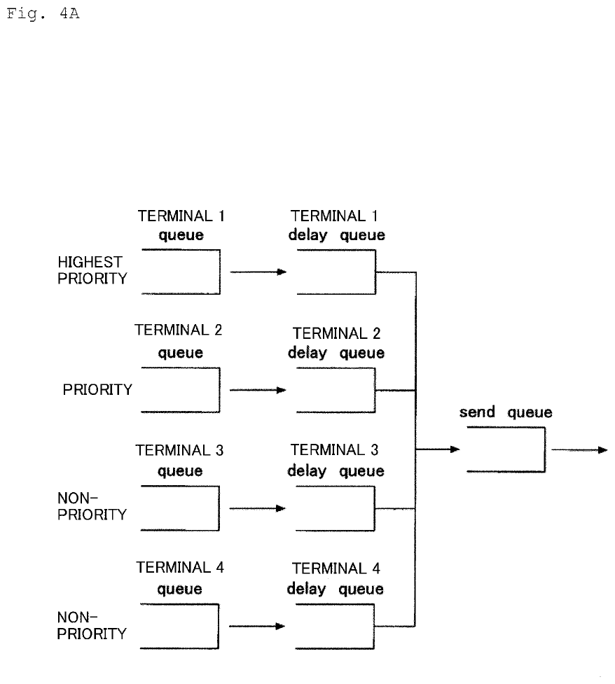

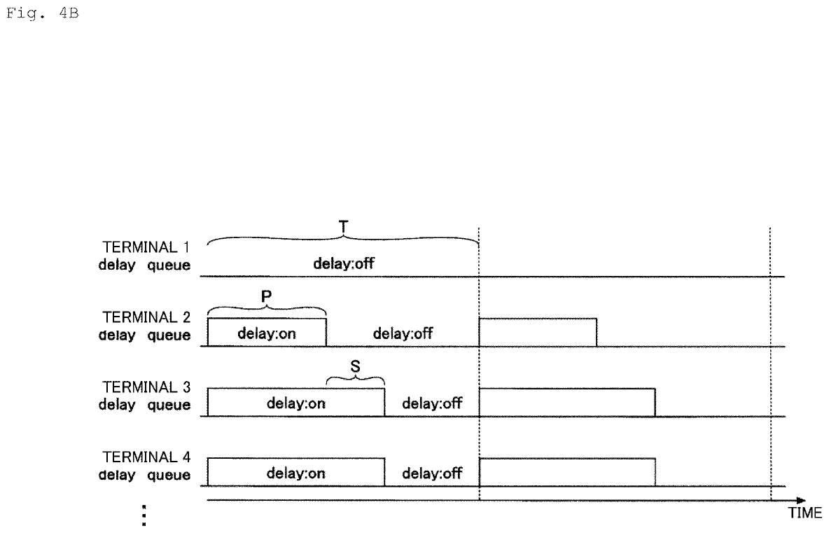

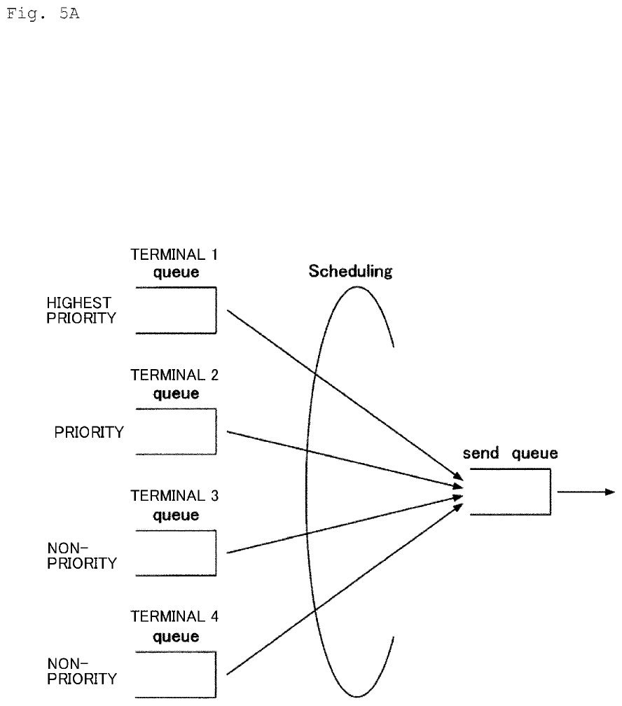

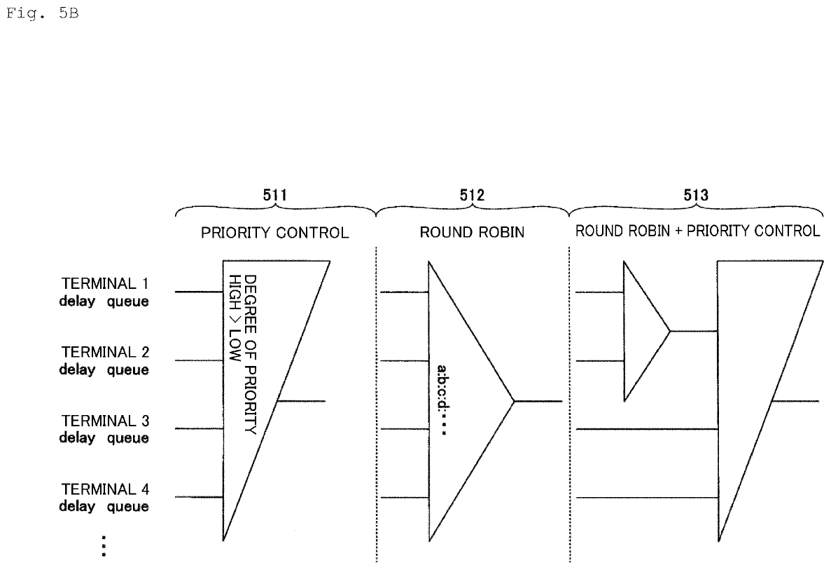

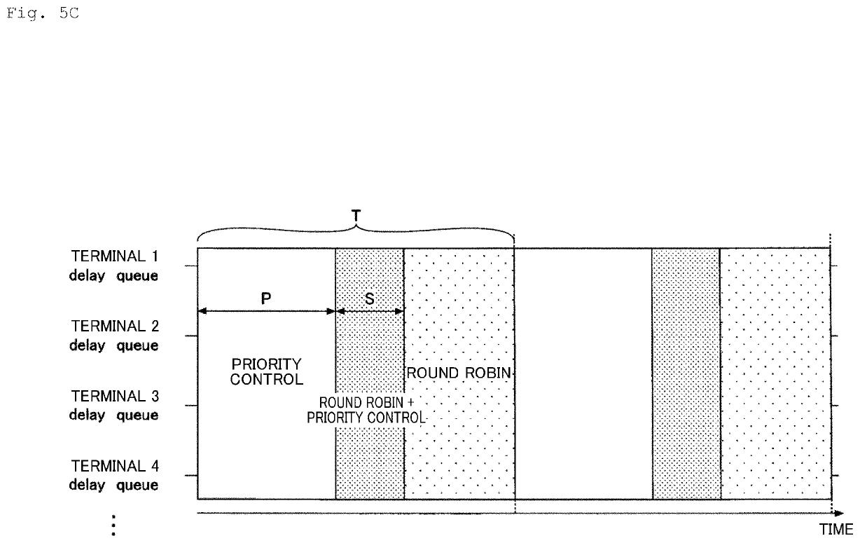

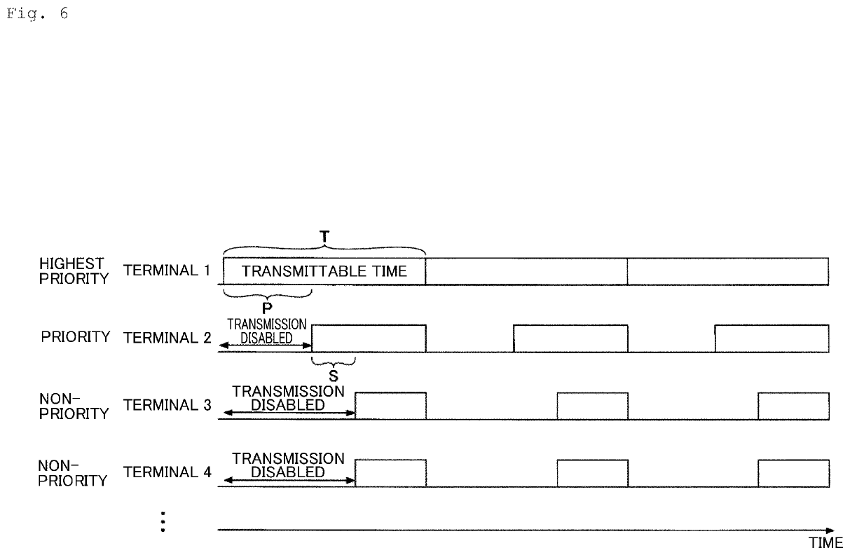

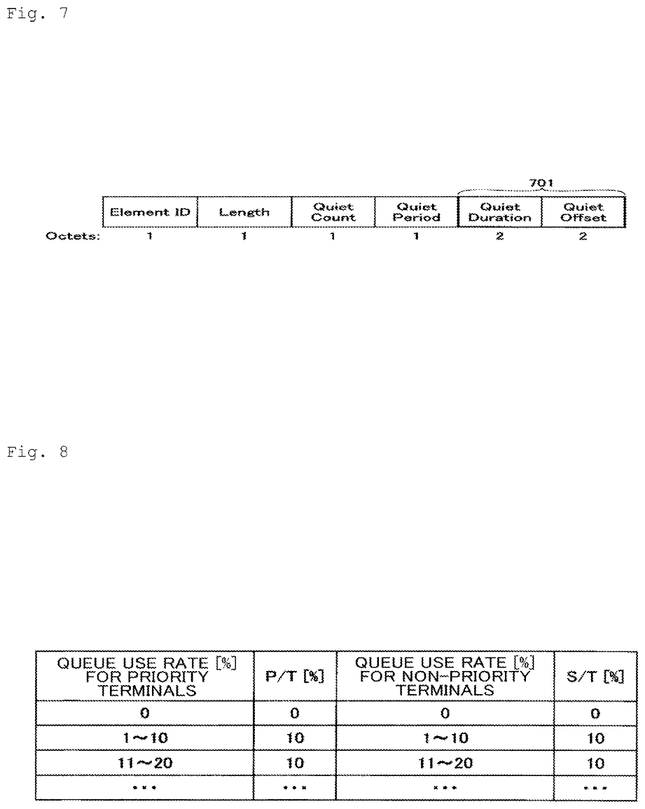

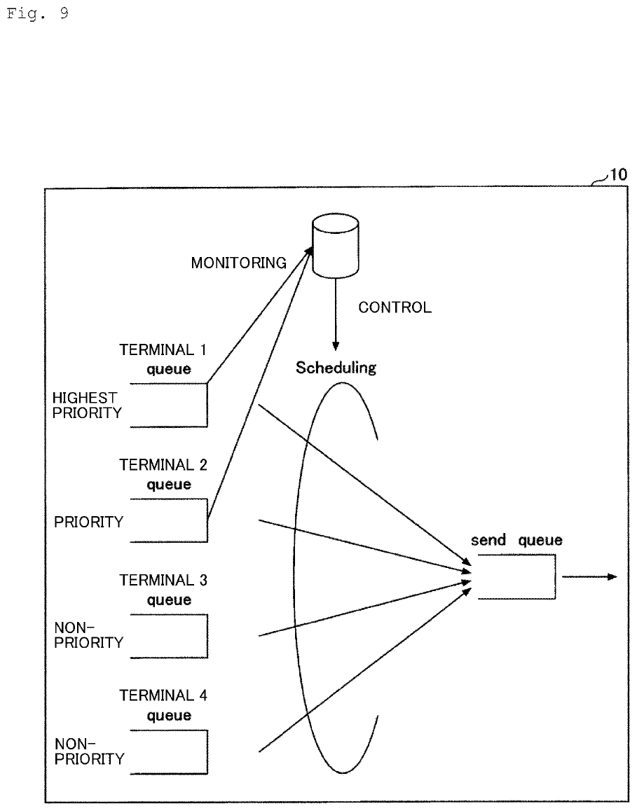

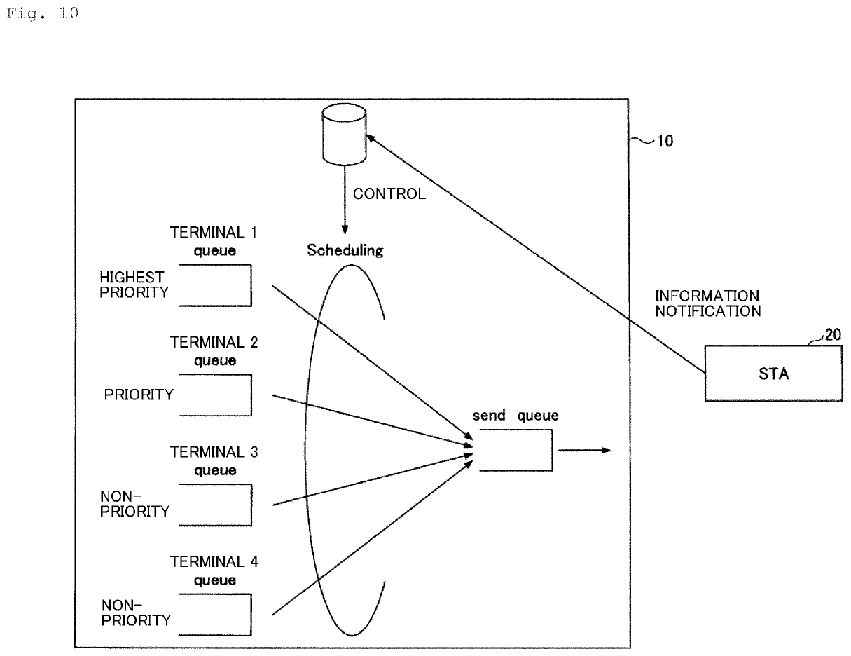

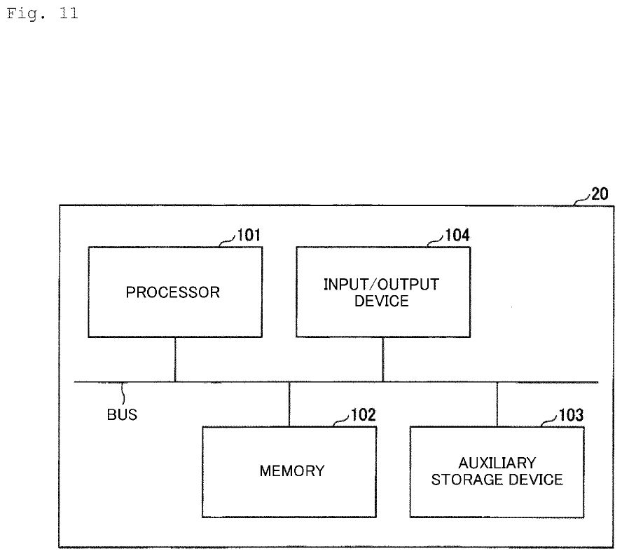

An example of the processing of the AP 10 according to the embodiment will be described with reference to FIGS. 3 to 10. FIG. 3 is a flowchart illustrating an example of processing of the AP 10 according to the embodiment. FIGS. 4A and 4B are diagrams illustrating an example in which the AP 10 according to the embodiment controls a time for transmitting a packet to each STA 20 using a delay queue. FIGS. 5A, 5B, and 5C are diagrams illustrating an example in which the AP 10 according to the embodiment controls a time for transmitting a packet to each STA 20 by scheduling. FIG. 6 is a diagram illustrating an example of a transmittable time of each STA 20 according to the embodiment. FIG. 7 is a diagram showing a format of a Quiet element defined in IEEE 802.11h. FIG. 8 is a diagram illustrating an example of setting a transmission time according to a use rate of a queue for a terminal according to the embodiment. FIG. 9 is a diagram illustrating an example of dynamically changing the transmittable time of each STA 20 in accordance with the use rate of a queue for each terminal according to the embodiment. FIG. 10 is a diagram illustrating an example of dynamically changing the transmittable time of each STA 20 in accordance with a situation related to communication quality in the STA 20 according to the embodiment.

A case where three degrees of priority, highest priority (degree of priority 1), priority (degree of priority 2), and non-priority (degree of priority 3), are used, and the degrees of priority of the four STAs 20 (terminals 1 to 4) are highest priority, priority, non-priority, and non-priority, respectively, will be described below as an example. The degrees of priority of the terminals 1 to 4 may be set by, for example, the respective terminals 1 to 4 transmitting a predetermined command to the AP 10. Further, the degrees of priority of the terminals 1 to 4 may be determined by the terminal transmission time control unit 14 on the basis of the information acquired from the terminals 1 to 4 by the STA information collection unit 12, for example.

In step S1, the terminal transmission time control unit 14 of the AP 10 sets a terminal control parameter which is a parameter related to communication of the STA 20. Here, the terminal transmission time control unit 14 may determine a parameter related to wireless communication from the AP 10 to each STA 20 (downlink direction) and a parameter related to wireless communication from each STA 20 to the AP 10 (uplink direction).

Thus, as shown in FIG. 6, for example, for each of the downlink direction and the uplink direction, a transmittable time corresponding to the degree of priority or the like of each STA 20 can be set. In the example shown in FIG. 6, the terminal 1 whose degree of priority is highest priority is set in a transmission enabled time period over the entire period of a cycle T. Also, the terminal 2 whose degree of priority is priority is set in a transmission disabled time period during a time length P from the head of the cycle T, and after the time length P has elapsed from the head in the cycle T, it is set in a transmission enabled time period. Also, the terminals 3 and 4 whose degrees of priority are non-priority are set in a transmission disabled time period during a time length obtained by adding a time length S to the time length P from the head of the cycle T, and after the time length obtained by adding the time length S to the time length P has elapsed from the head in the cycle T, they are set in a transmission enabled time period.

### (Setting in Downlink Direction)

The terminal transmission time control unit 14 may store each packet addressed to each STA 20 received from a network or the like in a queue for each STA 20 in the AP 10. Then, the terminal transmission time control unit 14 may set a time when each packet stored in the queue for each STA 20 can be transmitted to each STA 20 (hereinafter also appropriately referred to as a “first time”).

### ((Example of Control Using Delay Queue))

As shown in FIGS. 4A and 4B, the terminal transmission time control unit 14 may set a time when each packet stored in the queue can be transmitted to each STA 20 by using the delay queue. FIG. 4A shows that each packet addressed to each of the terminals 1 to 4 is stored in a queue for each terminal, then moved to a delay queue for each terminal, and transmitted from a transmission queue (send queue).

When the terminal transmission time control unit 14 moves a packet from the queue for each terminal to the delay queue for each terminal, the terminal transmission time control unit 14 may set a delay according to the degree of priority as shown in FIG. 4B. In this case, the terminal transmission time control unit 14 may first determine the cycle T for moving each packet from the queue for each terminal to the delay queue for each terminal. The value of the cycle T may be set in the AP 10 in advance.

When the terminal transmission time control unit 14 moves each packet from the queue for each terminal to the delay queue for each terminal, the terminal transmission time control unit 14 may switch the delay on and off according to the degrees of priority of the terminals 1 to 4. In the example shown in FIG. 4B, the terminal 1 whose degree of priority is highest priority is set with a delay off (no delay) over the entire period of the cycle T. Thus, the packet addressed to the terminal 1 whose degree of priority is highest priority is moved to the delay queue without delay and transmitted.

Also, the terminal 2 whose degree of priority is priority is set with a delay on during a time length P from the head of the cycle T, and after the time length P has elapsed from the head in the cycle T, it is set with a delay off. Also, the terminals 3 and 4 whose degrees of priority are non-priority are set with a delay on during a time length obtained by adding a time length S to the time length P from the head of the cycle T, and after the time length obtained by adding the time length S to the time length P has elapsed from the head in the cycle T, they are set with a delay off. Thus, the transmission time of the packet in the downlink direction can be controlled according to the degree of priority of each STA 20.

By setting the delay as shown in FIG. 4B, setting of transmittable time corresponding to the degree of priority or the like of each STA 20 as shown in FIG. 6 described above can be executed in communication in a downlink direction.

### ((Example of Control Using Scheduling))

As shown in FIGS. 5A to 5C, the terminal transmission time control unit 14 may control a time when each packet stored in the queue can be transmitted to each STA 20 by using the scheduling. FIG. 5A shows that each packet addressed to each of the terminals 1 to 4 is stored in a queue for each terminal, and then transmitted from a transmission queue (send queue) by a predetermined scheduling.

When the terminal transmission time control unit 14 moves a packet from the queue for each terminal to the transmission queue, the terminal transmission time control unit 14 may set scheduling of priority control according to the degree of priority as shown in FIG. 5B. In this case, the terminal transmission time control unit 14 may first determine the cycle T for moving each packet from the queue for each terminal to the transmission queue. The value of the cycle T may be set in the AP 10 in advance.

Then, the terminal transmission time control unit 14 moves each packet from a queue for each terminal to a transmission queue by scheduling corresponding to the degrees of priority of the terminals 1 to 4. In the example of FIG. 5C, scheduling 511 of priority control corresponding to the degree of priority shown in FIG. 5B is used for a time length P from the head of the cycle T. Then, after the time length P has elapsed from the head of the cycle T until the time length S elapses, as shown in FIG. 5B, scheduling 513 in which a round robin not related to the degree of priority and the priority control corresponding to the degree of priority are combined is used. Then, after the lapse of a time length obtained by adding the time length S to the time length P from the head in the cycle T, a schedule 512 of a round robin not related to the degree of priority shown in FIG. 5B is used.

By setting the scheduling as shown in FIGS. 5B and 5C, setting of transmittable time corresponding to the degree of priority or the like of each STA 20 as shown in FIG. 6 described above can be executed in communication in a downlink direction.

### (Setting in Uplink Direction)

The terminal transmission time control unit 14 may set a second time corresponding to the first time to each STA 20 as a time when a packet can be transmitted from each STA 20 by wireless communication. Thus, for example, it is possible to reduce matching between the time when the communication in the uplink direction is performed and the time when the communication in the downlink direction is performed.

In this case, as shown in FIG. 6, the terminal transmission time control unit 14 may first synchronize with the above-mentioned communication in the downlink direction, set the same cycle T as the cycle T in the downlink direction, and then add a predetermined offset to the start time of the cycle T in the communication in the downlink direction or the communication in the uplink direction. In this case, the terminal transmission time control unit 14 may shift a start point in time of the cycle T in the downlink direction and a start point in time of the cycle T in the uplink direction by half a cycle, for example, by adding an offset for half the time of the cycle T (T/2). Then, the terminal transmission time control unit 14 may set the times when the terminals 1 to 4 can transmit the packet to the AP 10 by wireless communication according to the degrees of priority of the terminals 1 to 4 and the transmission time in the downlink direction to the terminals 1 to 4.

In this case, similarly to the downlink direction, a transmittable time corresponding to the degree of priority or the like of each STA 20 as shown in FIG. 6 described above may be set for the uplink direction. In the example shown in FIG. 6, the terminal 1 whose degree of priority is highest priority can transmit the communication in the uplink direction over the entire period of the cycle T. Thus, the packet from the terminal 1 whose degree of priority is highest priority is transmitted without restriction of time.

Also, the terminal 2 whose degree of priority is priority is set with transmission disabled during a time length P from the head of the cycle T, and after the time length P has elapsed from the head in the cycle T, it is set with transmission enabled. Also, the terminals 3 and 4 whose degrees of priority are non-priority are set with transmission disabled during a time length obtained by adding a time length S to the time length P from the head of the cycle T, and after the time length obtained by adding the time length S to the time length P has elapsed from the head in the cycle T, they are set with transmission enabled. Thus, the transmission time of the packet in the uplink direction can be controlled according to the degree of priority of each STA 20.

The terminal transmission time control unit 14 may set the transmittable time of each STA 20 for each STA 20 by using, for example, the Quiet element defined in IEEE 802.11h (see “7.3.2.23 Quiet element” section of NPL 3). IEEE 802.11h is a standard defined for coexistence control of 5 GHz band wireless LAN in Europe.

FIG. 7 shows the format of the Quiet element defined by IEEE 802.11h. The Quiet element is data for providing a part of the dynamic frequency selection (DFS) function defined in IEEE 802.11h. By the DFS function, each STA 20 detects radar radio waves and stops transmission at the time of detection in order to avoid adverse effects on the C-band radar used for meteorological observation.

The Quiet element is defined to be used to define an interval at which no transmission occurs on the current channel. This interval can be used for each STA 20 to perform channel measurement without interference from other STAs 20 accommodated in the AP 10.

The terminal transmission time control unit 14 may set a cycle T and a transmittable time in the cycle T to each AP 10 by transmitting a command designating values of “Quiet Duration” and “Quiet Offset” 701 to each AP 10.

Subsequently, the terminal transmission time control unit 14 determines whether or not to perform dynamic control (step S2). Here, the terminal transmission time control unit 14 may determine that dynamic control is to be performed when a situation related to communication of a specific STA 20 satisfies a predetermined condition.

When it is determined that the dynamic control is not to be performed (NO in step S2), the process ends.

When the dynamic control is determined to be performed (YES in step S2), the terminal control parameter is changed (step S3), and the process proceeds to step S2.

In the process of step S3, in accordance with the situation regarding the communication of one or more specific STAs 20, the terminal transmission time control unit 14 may change the parameters related to the wireless communication in the downlink direction and the downlink direction of the specific STA 20 and the other STA 20. In this case, the situation related to the communication of a specific STA 20 may include, for example, a use rate of the queue for a specific STA 20 (queue for terminals in FIGS. 4A and 5A), information indicating a situation related to communication quality in one or more specific STAs 20, and the like. The information indicating the situation related to the communication quality in the STA 20 may include, for example, the communication quality in the STA 20, information indicating an application used in the STA 20, and the like.

### (Example of Control Based on Use Rate of Queue for Terminal in AP 10)

For example, when the use rate of the queue for a specific STA 20 is equal to or higher than a threshold, the terminal transmission time control unit 14 may increase a time when each packet stored in the queue for the specific STA 20 can be transmitted to the specific STA 20. Thus, for example, when the communication in the downlink direction of the specific STA 20 is busy, the busy state can be reduced (elimination of the busy state can be promoted) by increasing the time when the communication in the downlink direction of the specific STA 20 is available.

The example of FIG. 8 shows that, when the use rate of the queue for the terminal whose degree of priority is priority is 10%, the terminal transmission time control unit 14 sets the value of the ratio of the time length P to the cycle T of FIG. 4B to 10%. FIG. 9 shows an example in which the terminal transmission time control unit 14 monitors the use rate of the queue for each terminal to control scheduling.

For example, when the use rate of the queue for a specific STA 20 is equal to or higher than a threshold, the terminal transmission time control unit 14 may transmit a command for reducing the transmittable time in the uplink direction to the specific STA 20. Thus, for example, when the communication in the downlink direction of the specific STA 20 is busy, since the time when the communication in the uplink direction of the specific STA 20 is available is reduced, the collision between the communication in the downlink direction and the communication in the uplink direction of the specific STA 20 can be reduced. Therefore, the busy state can be reduced.

Also, for example, when the use rate of the queue for a specific STA 20 is equal to or higher than a threshold, the terminal transmission time control unit 14 may reduce a time when each packet stored in a queue for another STA 20 can be transmitted to the other STA 20 and transmit a command for reducing the transmittable time in the uplink direction to the other STA 20. Thus, for example, when the communication in the downlink direction of the specific STA 20 is busy, the collision between the communication in the downlink direction of the specific STA 20 and the communication in the downlink direction and the communication in the uplink direction of another STA 20 can be reduced. Therefore, the busy state can be reduced.

### (Example of Control Based on Communication Quality in STA 20)

For example, when the communication quality in the downlink direction of a specific STA 20 is equal to or less than a threshold, the terminal transmission time control unit 14 may increase a time when each packet stored in the queue for the specific STA 20 can be transmitted to the specific STA 20. For example, when the delay of communication in the downlink direction of a specific STA 20 is equal to or more than a threshold, and when the throughput in the downlink direction is equal to or less than a threshold, the terminal transmission time control unit 14 may determine that the communication quality in the downlink direction of the specific STA 20 is equal to or less than the threshold.

Thus, for example, when the communication quality in the downlink direction of the specific STA 20 is low (poor), the communication quality can be improved by increasing the time when the communication in the downlink direction of the specific STA 20 is available.

For example, when the communication quality in the downlink direction of a specific STA 20 is equal to or less than a threshold, the terminal transmission time control unit 14 may transmit a command for reducing the transmittable time in the uplink direction to the specific STA 20. Thus, for example, since the time when the communication in the uplink direction of the specific STA 20 is available is reduced, the collision between the communication in the downlink direction and the communication in the uplink direction of the specific STA 20 can be reduced. Therefore, the communication quality can be improved.

Also, for example, when the communication quality in the downlink direction of the specific STA 20 is equal to or less than a threshold, the terminal transmission time control unit 14 may reduce a time when each packet stored in a queue for another STA 20 can be transmitted to the other STA 20 and transmit a command for reducing the transmittable time in the uplink direction to the other STA 20. Thus, for example, since the collision between the communication in the downlink direction of a specific STA 20 and the communication in the downlink direction and the communication in the uplink direction of another STA 20 can be reduced, the busy state can be reduced.

### (Example of Control Based on Application Operating (Using) in STA 20)

For example, when an application currently operating (using) in a specific STA 20 is a predetermined application, the terminal transmission time control unit 14 may increase a time when each packet stored in the queue for the specific STA 20 can be transmitted to the specific STA 20. The predetermined application may include, for example, an application for making a voice call, an application for making a video conference, and the like, which require low communication delay and the like. Also, for example, when an application currently operating (using) in a specific STA 20 is the predetermined application, the terminal transmission time control unit 14 may transmit a command for increasing the transmittable time in the uplink direction to the specific STA 20. Thus, for example, when a predetermined application is used in the specific STA 20, the communication quality in the downlink direction and the uplink direction of the specific STA 20 can be improved.

Also, for example, when an application currently operating (using) in a specific STA 20 is a predetermined application, the terminal transmission time control unit 14 may reduce a time when each packet stored in a queue for another STA 20 can be transmitted to the other STA 20 and transmit a command for reducing the transmittable time in the uplink direction to the other STA 20. Thus, for example, since the collision between the communication of the specific STA 20 and the communication of another STA 20 can be reduced, the communication quality of the specific STA 20 can be improved.

FIG. 10 shows an example in which the terminal transmission time control unit 14 acquires information indicating a situation related to communication quality, such as information indicating communication quality in the STA 20 and an application currently operating (using) in the STA 20, and controls scheduling.

(Processing Example when there are Plurality of STAs 20 Having Same Degree of Priority)

When there are a plurality of STAs 20 having the same degree of priority, the terminal transmission time control unit 14 may set different transmittable time periods in the respective STAs 20 having the same degree of priority for the respective STAs 20. Further, when there are a plurality of STAs 20 having the same degree of priority, the terminal transmission time control unit 14 may set the same transmittable time period for the respective STAs 20 having the same degree of priority.

In this case, for example, the terminal transmission time control unit 14 may set different transmittable time periods in the respective STAs 20 whose degrees of priority are highest priority for the respective STAs 20. Further, the terminal transmission time control unit 14 may set the same transmittable time period for the respective STAs 20 whose degrees of priority are priority, for example, so that each STA 20 communicates within the transmittable time period.

### Modified Examples

In the above example, an example in which the terminal transmission time control unit 14 of the AP 10 determines and sets the terminal control parameter has been described. Instead of this, the terminal transmission time control unit 34 of the control device 30 may determine the terminal control parameter. Then, the AP setting unit 33 of the control device 30 may transmit the terminal control parameter determined by the terminal transmission time control unit 34 to the control device instruction reception unit 13 of the AP 10. The terminal transmission time control unit 14 of the AP 10 may perform setting based on the terminal control parameter received by the control device instruction reception unit 13.

Further, in the above example, an example in which the terminal transmission time control unit 14 of the AP 10 performs setting for each STA 20 by using the Quiet element has been described. Instead of this, the transmission control device 40 may perform setting for each STA 20.

### Other Configuration Examples

The function of each functional block in the AP 10 shown in FIG. 1 may be realized by a dedicated hardware (LSI or the like), or by a general-purpose computer having a processor (CPU, DSP, or the like) and a memory, and software operating on the computer.

FIG. 11 shows an example of the configuration of the AP 10 when the AP 10 is realized by using a computer and software.

As shown in FIG. 11, the AP 10 includes a processor 101, a memory 102, an auxiliary storage device 103, and an input/output device 104, and has a configuration in which these are connected by a bus.

For example, a program for realizing the processing of the AP 10 is stored in the auxiliary storage device 103 (computer-readable recording medium). When the AP 10 is operated, the program is read into the memory 102, and the processor 101 reads the program from the memory 102 and executes it. For example, the processor 101 executes the processing of the terminal transmission time control unit 14 or the like according to the program.

In addition, a “computer-readable recording medium” may include, for example, a flexible disk, a magneto-optical disk, a ROM, a portable medium such as a CD-ROM, a hard disk that is built into the computer system, or the like. Further, the “computer-readable recording medium” may also include an element for dynamically retaining a program for a short period of time such as a communication line when the program is transmitted over a network such as the Internet or a communication line such as a telephone line, or an element for retaining a program for a prescribed time period such as a volatile memory inside a server or a computer system that serves as client in that case.

Although the embodiment has been described above, the present invention is not limited to such a specific embodiment, and various modifications and changes can be made within the scope of the gist of the present invention described in the claims.

### REFERENCE SIGNS LIST

1 Communication system
10 AP
11 Transmission/reception unit
12 STA information collection unit
13 Control device instruction reception unit
14 Terminal transmission time control unit
20 STA
30 Control device
31 Transmission/reception unit
32 AP information collection unit
33 AP setting unit
34 Terminal transmission time control unit
40 Transmission control device

1. A relay method that is executed by a relay device that relays communication between each of terminals accommodated by wireless communication and an external device, the relay method comprising:
setting, for each terminal of the terminals, a time period from storing a packet in a queue until transmitting the packet to the terminal as a first time period; and
setting, for each terminal of the terminals, a time interval in which the terminal is allowed to transmit a packet by the wireless communication as a second time period corresponding to the first time period.

2. The relay method according to claim 1, wherein, in the setting the time interval as the second time period, the time interval is set by using a Quiet element defined in IEEE 802.11h.

3. The relay method according to claim 1, wherein, in the setting the time interval as the second time period, for a first terminal having a first degree of priority and a second terminal having a second degree of priority lower than the first degree of priority from among the terminals, a cycle of the time interval in which the terminal is allowed to transmit the packet by the wireless communication is set to a same cycle: the time interval, in the cycle, in which the first terminal is allowed to transmit the packet by the wireless communication is set to a first time length; and the time interval, in the cycle, in which the second terminal is allowed to transmit the packet by the wireless communication is set to a second time length, the second time length being shorter than the first time length.

4. The relay method according to claim 3, wherein in the setting the time interval as the second time period, the first time length is changed based on at least one of a use rate of the queue, a communication quality of the first terminal, or information indicating an application used by the first terminal.

5. A relay device comprising:
a transceiver configured to relay communication between each of terminals accommodated by wireless communication and an external device;
a processor; and
a memory that includes instructions, which when executed, cause the processor to
set, for each terminal of the terminals, a time period from storing a packet in a queue until transmitting the packet to the terminal as a first time period; and
set, for each terminal of the terminals, a time interval in which the terminal is allowed to transmit a packet by the wireless communication as a second time period corresponding to the first time period.
